(19) United States
(12) Patent Application Publication
(10) Pub. No.: US 2008/0113066 A1
(43) Pub. Date: May 15, 2008

(54) Organic electrolyte formula

(76) Inventors: Jay C. Highman, Westerville, OH (US); Jeffery W. Liebrecht, Columbus, OH (US)

Correspondence Address: GALLAGHER & DAWSEY CO., L.P.A., P.O. BOX 785, COLUMBUS, OH, 43216, US

(21) Appl. No.: 11/598,613

(22) Filed: Nov. 13, 2006

(51) Int. Cl. A23L 2/02; A23L 2/52; A23L 2/68

(52) U.S. Cl. 426/72; 426/250

(57) ABSTRACT

This invention relates to an electrolyte nutritional beverage substantially free of chemical pesticides, antibiotics, hormones, herbicides, non-genetically modified plants and chemical solvents. The inventive oral electrolyte formula preferably uses Vitamin C as a stabilizer for the color and flavor.

The inventive beverage provides a smooth texture, a pleasant taste and a light, refreshing mouthfeel. The inventive beverage also has excellent physical stability over shelf life. This is due to the lack of artificial flavors and yet achieves a desired osmolarity with organic dextrose, fructose and white grape juice.

### TECHNICAL FIELD

This invention relates to an improved hydration formula which meets the organic criteria of the USDA National Organic Program and possesses highly acceptable taste and nutritional value. The hydration formula uses organic white grape juice to provide a product that has excellent shelf stability and a desired osmolarity.

### BACKGROUND OF THE INVENTION

A growing number of individuals are turning to “organic” foods as their preferred source of nutrition. Organic foods are not genetically modified and are grown and prepared without the use of chemical pesticides, growth hormones, antibiotics, herbicides or synthetic fertilizers and are processed without the use of solvents such as hexane. Further, organic ingredient processing is like kosher processing in that it separates production lines that are used for organic and non-organic ingredients. In the alternative, special cleaning procedures are used between non-organic and organic runs.

A number of certification boards and some states, such as California, have regulations that must be followed for a food ingredient or food product to be labeled as organic. One such board is the National Organic Standards Board (NOSB). The NOSB requires organic growers not to have used chemical pesticides, herbicides or fertilizers on their land for at least three years. NOSB standards currently allow up to 5 percent of the ingredients in nutritional products labeled “organic” to be non-organic, provided those ingredients are not widely available in organic form.

The consuming public is aware that organic foods reduce the health risks associated with consuming foods that are tainted with chemical solvents, pesticides, herbicides, and the like. While adults can carefully choose their source of nutrition, infants, toddlers and children are forced to consume liquid formulas that are not organic. The present invention is directed to a hydration formula that is organic and provides an unexpected result in self life and low osmolarity.

Conventional hydration formulas are derived, to a large extent, from salts and minerals. Many hydration formulas have carbohydrates such as lactose, dextrin, sucrose, maltose, starches as well as vitamins and minerals. These components are present in suitable amounts to meet the requirements of osmolarity and mineral balance.

Dehydration is found in many patients admitted to hospitals. This happens not only in developing countries, but also in those with a high socioeconomic level. Proper nutritional support for such patients is an important factor for therapy and recovery. It is, therefore important to administer a nutritionally balanced organic formula free of contaminates such as pesticides and herbicides, adequate to the needs of the patient.

This is especially true for those patients where conventional hydration is contra-indicated (gastroenterological patients) or insufficient (hypercatabolic patients). Further, these patients are at greater risk for developing complications that are associated with formulations contaminated with pesticides, herbicides and chemical solvents.

### BACKGROUND ART

Numerous hydration formulas have been developed and patented over the years. Representative formulas are disclosed in the following U.S. patent numbers: U.S. Pat. Nos. RE38,604; 6,770,305; 6,743,821; 6,596,702; 6,572,898; 6,455,511; 6,429,198 and 6,296,892. The teachings of these patents, as they evidence the state of the art, are herein incorporated by reference.

While much work has been done to prepare various hydration formulas, there has been no effort put forth to develop an organic hydration formula. It is thus apparent that a need exists for a pleasant tasting organic hydration formula that avoids artificial colors and sweeteners.

### DISCLOSURE OF THE INVENTION

There is disclosed a rehydration nutritional formula, said formula comprising: 1) organic white grape juice concentrate; 2) organic dextrose, tapioca or rice dextrose; 3) an acid selected from malic, tartaric, lactic, hydrochloric, phosphoric and mixtures thereof; 4) water; 5) and minerals.

As used herein and in the claims the values reported are per liter of formula for a ready to feed (RTF) hydration liquid nutritional formula. The invention is directed to an oral electrolyte formula (OEF) that uses organic white grape juice concentrate. White grape juice is recommended by the medical community as the first juice introduced to an infant or toddler. Research has revealed that white grape juice is an appropriate juice for infants and toddlers because it does not contain sorbitol or the imbalance of natural sugars, making it easier to digest than apple and pear juice.

One aspect of this invention is the discovery that white grape juice concentrate is effective in masking the foul flavor of the minerals, sodium, potassium and chloride. Another aspect of the present invention is that white grape juice concentrate in combination with the other components of the OEF is well tolerated by children recovering from diarrhea as it holds the correct combination of carbohydrates without the presence of sorbitol.

In addition organic white grape juice concentrate contributes no discernable flavor and thus allows for an apple flavored product and a grape flavored product. The present invention provides a fructose content from white grape juice concentrate that aids in minimizing osmolality so that proper hydration can be obtained. The medical community has recommended that the ratio of sodium plus potassium to chloride (as mEq) in a hydration formula be maintained in the range of 1.5 to 2.0. The present invention surprisingly provides that ratio through the use of organic ingredients. The OEF of this invention contains no preservatives, artificial colors, flavors or sweeteners.

One source of the organic white grape juice concentrate is Organic Ingredients of Aptos, Calif., 95003. The minerals can be provided in the form of a premix from Fortitech. In the present invention, all of the fructose is naturally derived from the organic white grape juice and none is added to meet the desired dextrose to fructose ratio of 4.7 to 1.2 grams/8 fl oz.

Preferably, the malic acid or the equivalent is added to obtain a pH of between 3.5 and 6.0 for the OEF. Ascorbic acid can also be used as it provides color stability during self life and provides a source of Vitamin C.

In contrast to the prior art hydration formula, the present invention utilizes organic white grape juice concentrate with or without apple juice. The white grape juice concentrate contains natural malic acid.

### SUMMARY OF THE INVENTION

The present invention is directed to an OEF wherein the beverage may be in the ready-to-drink form (single strength) or a concentrate. The pH of the OEF is in the range of from about 3.5 to about 6.0, with a pH of 4.0 to 6.0 being more preferred and a pH of 4.0 to 5.0 being most preferred.

As used herein, the term “beverage” refers to a liquid composition which is in a single-strength, ready to feed form (RTF). Beverages of the present invention typically comprise at least 70% by weight, preferably at least 80% by weight water. Beverages contemplated within the scope of this invention may also be obtained from adding water to concentrates and powders.

As used herein, the term “comprising” or “comprises” means various components can be cojointly employed in the beverages and concentrates of the present invention. Accordingly, the more restrictive terms “consisting essentially of” and “consisting of” are embodied in the term “comprising”.

The carbohydrate may be any carbohydrate source appropriate for use in organic beverages. However, one preferred source of organic carbohydrate is organic dextrose. It has been found that the use of organic dextrose is highly effective in masking the offensive flavors from the vitamins and minerals added to the beverage. Further, organic dextrose provides a nutritional benefit compared to the empty calories associated with refined sources of carbohydrate such as sucrose and corn syrup solids. Refined sugars upon consumption go directly into the blood stream where they spike insulin levels, promote excess fat storage, elevate triglycerides, affect brain chemistry and impair absorption of trace minerals. It is preferred that the organic OEF comprise about 1 to 15 grams of organic dextrose per 100 kcal of formula and most preferably from about 2 to about 10 grams per 100 kcal of RTF formula.

An additional aspect of the invention relates to simultaneously achieving an OEF beverage that uses organic white grape juice concentrate juice as a novel source of carbohydrate, which contains a nutritionally significant level of vitamins. In a preferred embodiment the OEF also contains ascorbic acid (Vitamin C).

The organic white grape juice concentrate is produced from three year certified organic white grapes. The grapes are harvested at peak sugar levels, then promptly crushed and the juice processed to preserve the fresh picked quality of the fruit. The Brix is typically about 68 and the pH is about 3.5.

An additional aspect of the present invention relates to the OEF's pleasant taste and light mouthfeel. It has been discovered that to achieve the goals of pleasant taste and good mouthfeel, the organic dextrose should be used with organic white grape concentrate with the possible additional use of apple juice.

A clinical study has determined that infants and toddlers can easily digest white grape juice. White grape juice has a good balance of sugars and lacks sorbitol. One source of this material is available from Welch's Inc. One aspect of the present invention is that the organic white grape juice provides all of the fructose, naturally derived, to give a desired dextrose/fructose ratio of about 4.7 gm dextrose to about 1.2 gm fructose per 8 fluid oz. serving.

The OEF of this invention also has a preferred osmolality (osmolarity) of less than about 300 mOsm/Kg water and preferably about 270 mOsm/Kg water, thus making the OEF isotonic.

The sweetness of the inventive OEF is due in part to the use of organic dextrose, malic acid and the organic white grape juice concentrate. This synergistic combination masks the bitter attributes of the sodium chloride and the potassium chloride.

In one embodiment the beverage according to this invention can be prepared with the following steps and components:
1) to a mixing tank was added the required amount of cold filtered water;
2) the mineral and vitamin premix was then added and mixed until dissolved;
3) the all natural organic compliant flavors and natural colors were then added and mixed to dissolve;
4) the organic white grape juice concentrate juice was then added and mixed to dissolve; and
5) the acid was then added (i.e. malic) to a pH of about 4.0 to 5.0.

The OEF according to the invention would be especially beneficial for toddlers/children of 1-10 years of age. Various modifications of components, such as the organic acids, can be made without departing from the fundamental discovery that use of organic white grape juice concentrate and dextrose can create an organic OEF with good self life and organoleptic properties.

### INDUSTRIAL APPLICABILITY

Some patients, infants and toddlers in need of hydration supplementation should not be exposed to the chemical residues that are present in commercially available hydration products. The product of this invention will also offer patients, infants and toddlers in need of electrolyte supplementation a new beverage that will improve intake and thereby improve nutritional status. The organic product of this invention provides a high level of nutritional value in a beverage which will be found useful in the medical community and readily accepted by parents of infants that know the value of organic products.

In accordance with the foregoing disclosure, it will be within the ability of one skilled in the relevant arts to make modifications to the present invention, such as through the substitution of equivalent materials and/or their amounts, without departing from the spirit of the invention as reflected in the appended claims.

We claim:

1. A beverage comprising:
a) water;
b) from about 0.1 to about 0.9 gms of vitamins and minerals per 100 kcal of beverage;
c) from about 1.0 to about 10.0 gms per 100 kcal of a source of organic juice selected from the group consisting of white grape concentrate;
d) an acid selected from the group consisting of malic, tartaric, lactic, hydrochloric, phosphoric and mixtures thereof; and
e) about 1.0 to about 15 gms per 100 kcal of organic dextrose.

2. The beverage according to claim 1 wherein said source of acid is malic acid.

3. The beverage according to claim 1 wherein said beverage has a pH of from 3.5 to 6.0.

4. The beverage according to claim 1 wherein said beverage additionally comprises organic natural flavors, natural colors and mixtures thereof.

5. The beverage according to claim 1 wherein said beverage is in the form of a concentrate.

6. The beverage according to claim 1 wherein said beverage has a dextrose/fructose ratio of about 4.7 to 1.2.

7. The beverage according to claim 1 wherein said beverage has an osmolality of less than 300 mOsm/Kg water.

8. The beverage according to claim 7 wherein said beverage has an osmolality of about 270 mOsm/Kg water.

9. A process for the preparation of a beverage according to claim 1 which comprises:
1) to a mixing tank add the required amount of water;
2) add a mineral and vitamin premix and mix until dissolved;
3) add flavors and colors and mix to dissolve;
4) add organic white grape juice and mix to dissolve;
5) add acid to a pH of about 4.0 to 5.0.
